(19) United States
(12) Patent Application Publication
(10) Pub. No.: US 2007/0264099 A1
(43) Pub. Date: Nov. 15, 2007

(54) Expansion screw

(75) Inventors: Pan-Ching Huang, Changhua (TW); Chih-Tsung Chen, (US)

Correspondence Address: BRUCE H. TROXELL;SUITE 1404, 5205 LEESBURG PIKE, FALLS CHURCH, VA, 22041, US

(73) Assignee: JOKER INDUSTRIAL CO., LTD.

(21) Appl. No.: 11/430,920

(22) Filed: May 10, 2006

(51) Int. Cl. F16B 13/04

(52) U.S. Cl. 411/38

(57) ABSTRACT

An expansion screw has at least three folding sections to provide a bracing effect. It includes an anchor nail and a bolt. The anchor nail has a tubular body formed by rolling a plate and an action zone in the middle portion. The action zone has a plurality of longitudinal slots and a plurality of strips. Each strip has a first section, a second section and a third section. After the expansion screw receives an action of a tensile force tool, the second section, due to having a upper end and a lower end that are weaker, can channel and concentrate stress to generate a bending and drive the first and third sections to bend in desired directions. Thereby the second section is folded over the first section and the third section presses the first section to form a bracing effect. The folding and bracing of the material can prevent defective construction and damage caused by excessive compression on the rim of the construction hole.

### BACKGROUND OF THE INVENTION

1. Field of the Invention

The present invention relates to an expansion screw and particularly to an expansion screw that has at least three folding sections to generate a bracing effect when subject to action of a tensile force tool to prevent construction defect and damage resulting from excessive compression on the rim of the working holes.

2. Description of the Prior Art

The conventional expansion screw 1 nailed on a wall (such as a gypsum panel) for hanging articles (referring to FIGS. 1 and 2) mainly includes an anchor nail 10 and an action zone 11 with a plurality of longitudinal slots 12 and strips 13 formed thereon. Each of the strips 13 has the center portion bulging slightly outwards to form a upper section 131 and a lower section 132 on a upper side and a lower side that are tapered on two sides. Through a tensile force tool F to exert a tensile force P on a bolt 14, the action zone 11 is expanded outwards and deformed to anchor the anchor nail 10 on a wall W1. The ideal condition after construction is shown in FIG. 2. But in practice the construction result is not always like the one shown in FIG. 2. A defective anchoring could happen as shown in FIG. 3. This is because the strip 13 is formed in two sections, and the upper section 131 and the lower section 132 cannot be folded and overlapped to achieve a desired bracing effect. Sometimes the upper section 131 and the lower section 132 are almost in parallel and result in the upper section 131 not clamping the surface of the wall W1 tightly to form a secure anchoring. Sometimes an excessive squeeze occurs on the rim of the working hole B1 and causes the action zone 11 to expand and tilt outwards. This could damage the wall W1 around the rim of the working hole B1 (as shown in FIG. 3). When a wall W2 is thinner (referring to FIG. 4), the action zone 11 of the expansion screw 1 could penetrate inversely into the wall W2 and damage the surface of the wall W2. To overcome the aforesaid problems, an expansion screw 2 (such as U.S. Pat. No. 4,986,710) has been introduced. It mainly includes an anchor nail 20 and a bolt 21. The anchor-nail 20 has a nut 201 on one end and a heat portion 202 on another end, and an action zone 203 in the middle portion. The action zone 203 includes a plurality of undulant strips 204. While such a structure can enhance the strength of the expansion screw 2, the strips 204 cannot be folded to provide a bracing effect when subject to the action of a tensile force tool F. It could even damage the wall W3 around the rim of the working hole B3 (as shown in FIG. 6).

The Applicant has proposed a solution (referring to U.S. Pat. No. 6,609,866, U.K. patent No. 2379722, TWN Patent No. 509292) as shown in FIG. 7. It aims to achieve the working result shown in FIG. 8 when subject to the action of a tensile force tool F. But in practice there is still a lot to be desired. The expansion screw 5, like the conventional ones, has an action zone 51 which has strips with a two-section structure consisting of a upper section 511 and a lower section 512. During the expansion process it is difficult to achieve the folding and bracing effect shown in FIG. 8. And the expanded action zone 51 also could penetrate inversely into the wall W4 as shown in FIG. 4 and result in damage of the surface of the wall.

### SUMMARY OF THE INVENTION

In view of the aforesaid disadvantages occurred to the conventional expansion screws that mainly have an action zone consisting of two-section strips and cannot be folded and overlapped into three sections or more to achieve the bracing effect, the object of the present invention is to provide an expansion screw that has at least three sections to generate folding and bracing effect to prevent construction defect and damage of wall caused by excessive compression on the rim of the working hole. The expansion screw of the invention includes an anchor nail and a bolt. The anchor nail has a tubular body formed by rolling a plate. It has an action zone in the middle portion which includes a plurality of longitudinal slots and a plurality of strips. Each strip has a first section, a second section and a third section.

The first section is located on a upper side abutting a nail cap of the anchor nail and is extended downwards and outwards in an inclined manner from the edge of one end of the nail cap to be in contact tightly with a wall surface after expansion.

The second section is located on a lower side of the first section and connected to the first section to form an inner angle greater than 90°. The second section inclines gradually downwards and inwards from the connecting portion with the first section and is formed at a length smaller than the first section. After expansion, the second section is folded and in contact with the first section.

The third section is located on a lower side of the second section and formed in a flat and straight manner, and is connected to the second section to form an outer angle greater than 90°. The third section is extended downwards until reaching the edge of a head end of the anchor nail. After expansion it braces the first section.

In one aspect, the first section and the second section are connected on an outward bulged location which has a first stamp line formed by stamping with a mold to serve as a bend line.

In another aspect, the second section and the third section are connected with a second stamp line formed on the connecting portion by stamping with another mold to serve as another bend line.

In yet another aspect, the third section has a length greater than the second section to form an enhanced compression bracing on the first section after the expansion screw receives the action of a tensile force tool.

In still another aspect, the second section has two tapered lateral sides to form a width smaller than that of the first and third sections so that after expansion stress can be channeled and concentrated to the upper and lower ends of the second section (namely on the first and second stamp lines), and the second section can be in contact closely to the first section and draws the third section to form pressing and bracing.

In yet another aspect, the upper and lower ends of the second section, namely on the first and second stamp lines, have respectively a notch on two lateral sides to reduce the strength and channel the stress to the locations where the first and second stamp lines are formed to facilitate bending. Thereby the second section can be in contact closely with the first section and draw the third section to form pressing and bracing.

In yet another aspect, the upper and lower ends of the second section, namely on the first and second stamp lines, heave respectively a groove on an inner side to reduce the strength and channel the stress to the locations where the first and second stamp lines are formed to facilitate bending. Thereby the second section can be in contact closely with the first section and draw the third section to form pressing and bracing.

In yet another aspect, the second and third sections have respectively a reinforced rib to enhance the bracing strength of the strip after expansion.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional expansion screw.

FIG. 2 is a sectional view of a conventional expansion screw after finish of construction.

FIG. 3 is a sectional view of a defective construction of a conventional expansion screw.

FIG. 4 is a sectional view of another defective construction of a conventional expansion screw.

FIG. 5 is a schematic view of another conventional expansion screw.

FIG. 6 is a sectional view of a defective construction of another conventional expansion screw.

FIG. 7 is a schematic view of yet another conventional expansion screw.

FIG. 8 is a sectional view of a construction condition of yet another conventional expansion screw.

FIG. 9 is a perspective view of the invention.

FIG. 10 is a plane view of the invention.

FIG. 11 is a sectional view of the invention.

FIG. 12 is a sectional view of the invention after finish of construction.

FIG. 13 is another sectional view of the invention after finish of construction.

FIG. 14 is a schematic view of a second embodiment of the second section of the invention.

FIG. 15 is a schematic view of a third embodiment of the second section of the invention.

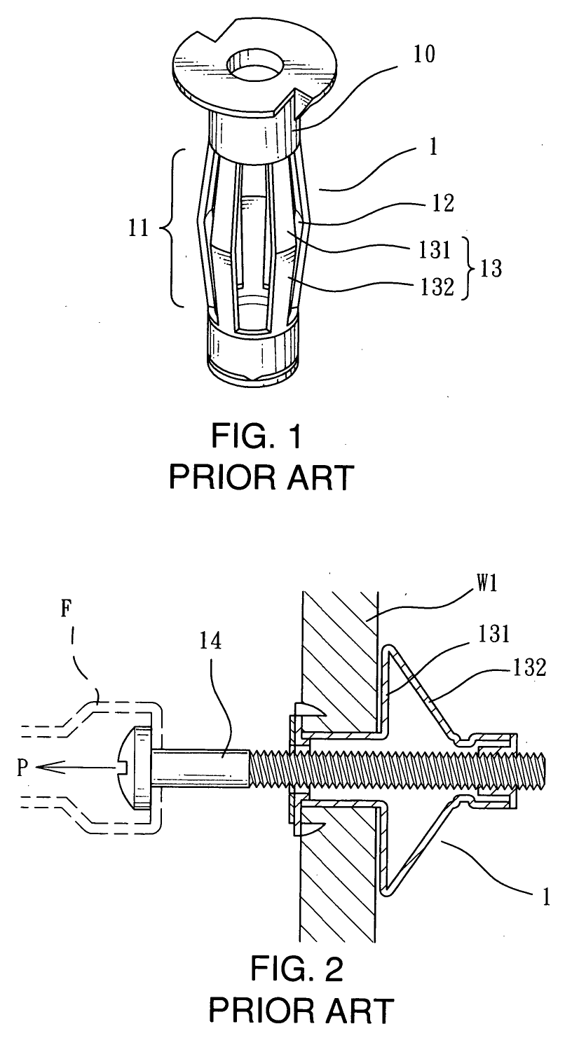

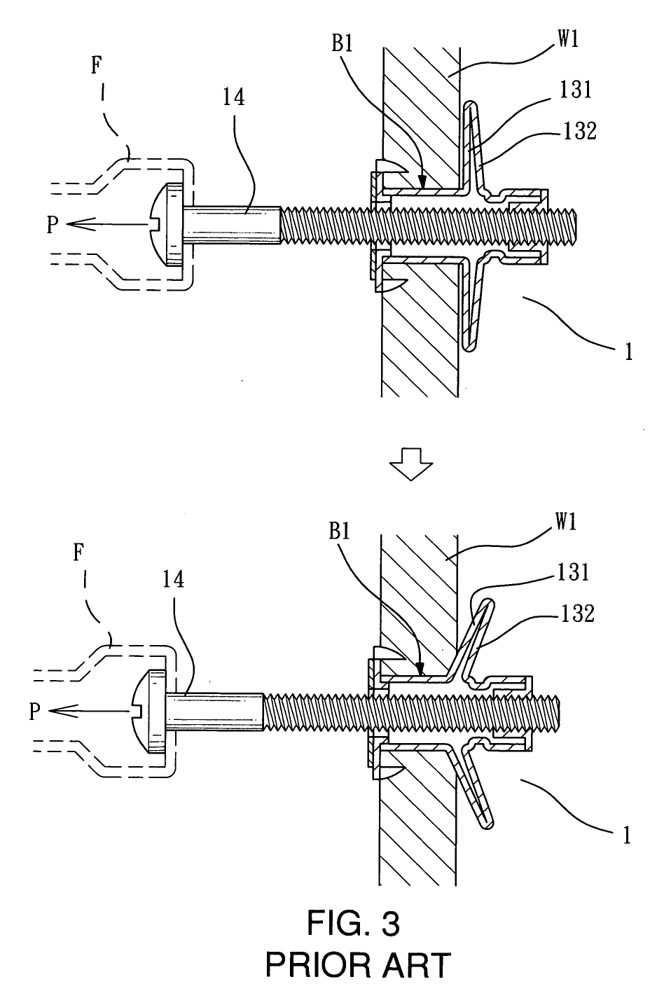

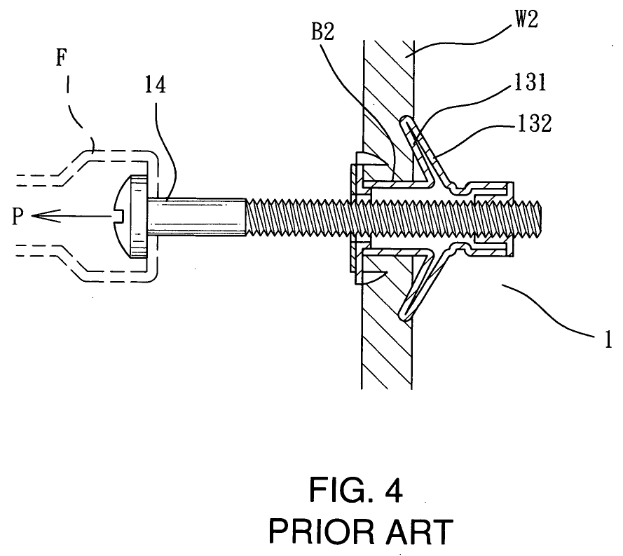

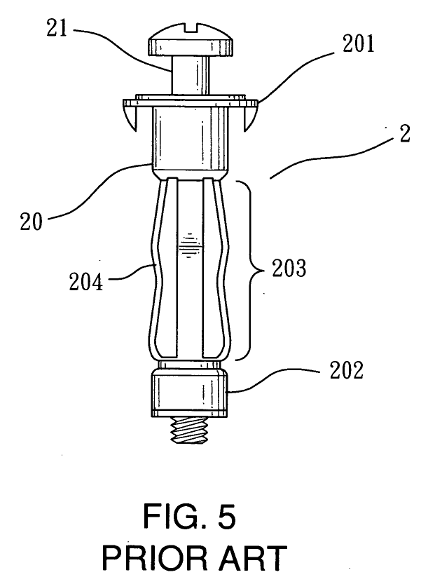

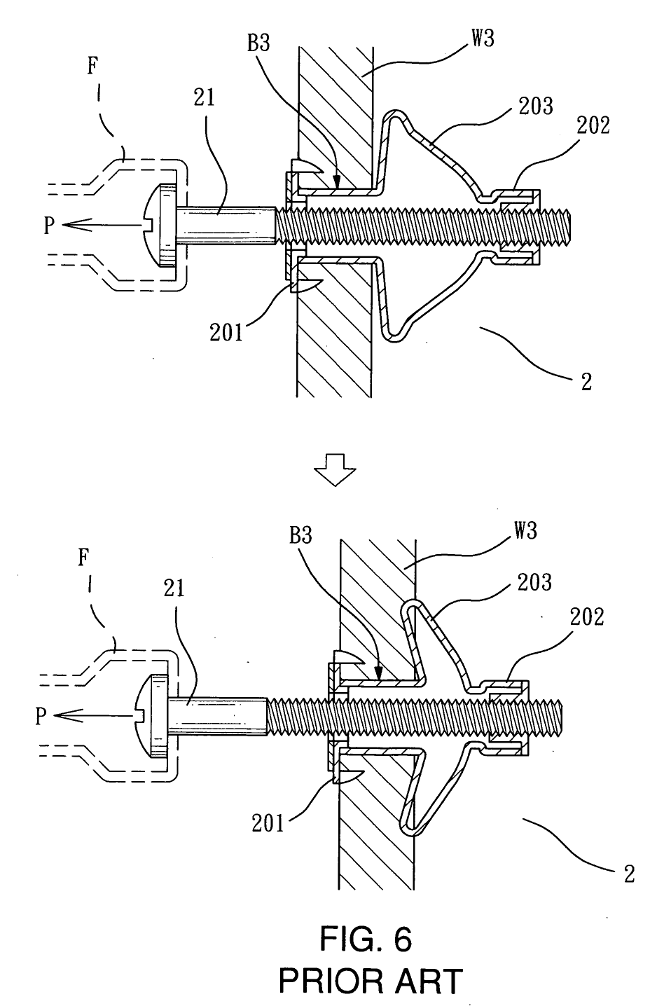

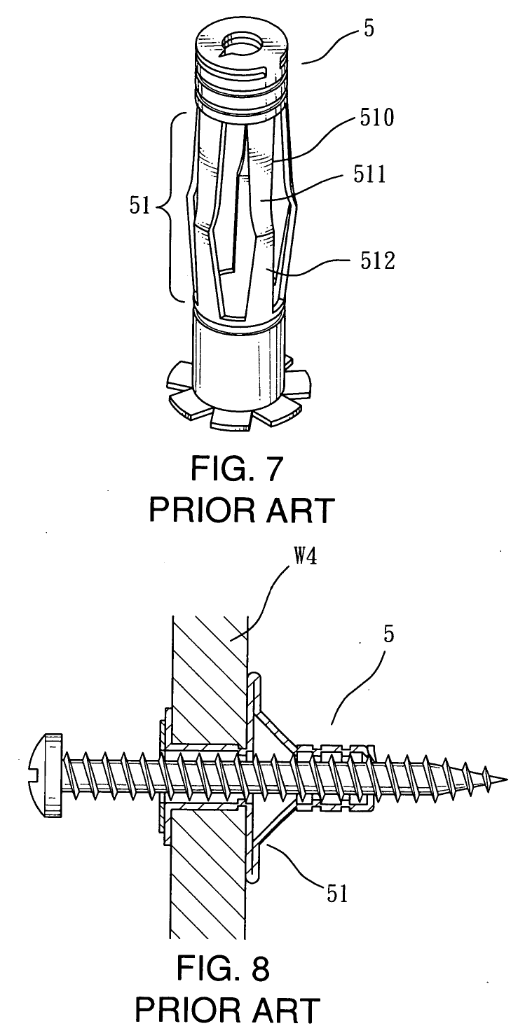

### DESCRIPTION OF THE PREFERRED EMBODIMENTS

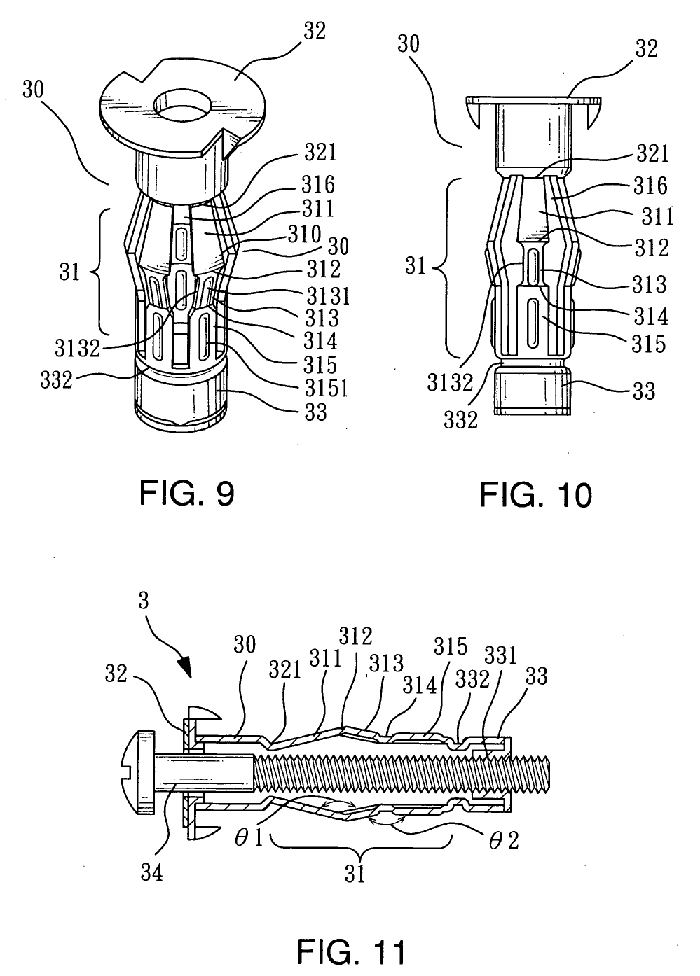

Referring to FIGS. 9 through 12, the expansion screw 3 according to the invention includes an anchor nail 30 and a bolt 34. The anchor nail 30 has a tubular body formed by rolling a plate. It has a nail cap 32 on a upper portion, an action zone 31 in a middle portion and a head end 33 on a lower portion, and an internal screw hole 331 inside to be screwed with the bolt 34. The action zone 31 has a plurality of longitudinal slots 316 and a plurality of strips 310. Each of the strips 310 has a first section 311, a first stamp line 312, a second section 313, a second stamp line 314 and a third section 315.

The first section 311 is located on a upper portion of the strip 310 adjacent to the nail cap 32 and is extended downwards and outwards in an inclined manner from an end edge 321 of the nail cap 32 to be in contact tightly with the surface of a wall W after expansion.

The first stamp line 312 is located on the connecting portion of the first section 311 and the second section 313 on an outward extended location and is a bend line formed by stamping with a mold.

The second section 313 is located below the first section 311 and connected to the first section 311 to form an inner angle θ1 greater than 90°. The second section 313 inclines gradually downwards and inwards and has a length smaller than the first section 311 to be folded in contact with the first section 311 after expansion.

The second stamp line 314 is on the connecting portion of the second section 313 and the third section 315, and is another bend line formed by stamping with another mold.

The third section 315 is located below the second section 313, and is flat and straight, and connected to the second section 313 to form an outer angle θ2 greater than 90°. The third section 315 is extended downwards until reaching an edge 332 of the head end 33. After expansion it braces the first section 311.

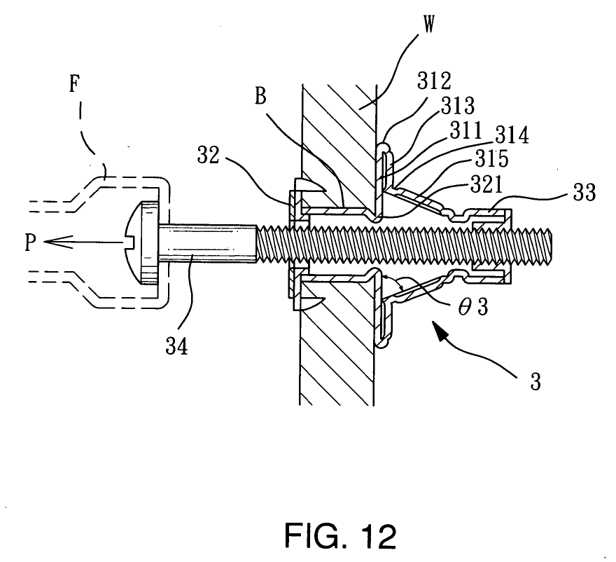

By means of the construction set forth above, when in use, the expansion screw 3 is inserted into a working hole B of the wall W (as shown in FIG. 12). The bolt 34 is pulled by a tensile force P from a tensile force tool F. Due to the action zone 31 is the weakest portion of the entire anchor nail 30, it is expanded outside and deformed. As the second section 313 is much weaker than the first and third sections 311 and 315, and two lateral sides 3132 thereof are tapered at a smaller width to form a weaker portion, stress is channeled and concentrated on the first and second stamp lines 312 and 314 to form bending, and they are drawn towards the nail cap 32. The first section 311 is moved to be in contact with the surface of the wall W first; then the second section 313 is folded due to the continuous tensile force P to be in contact with the first section 311 to form an overlapping condition and draw the third section 315 forwards. Due to the third section 315 is longer than the second section 313, thus a bracing angle θ3 is formed between the third section 315 and the first section 311 to form a pressed anchoring to make the first section 311 in contact with the surface of the wall W tightly, and the second section 313 is folded over the first section 311 closely. With the pressing and bracing of the third section 315, a three-section folding and bracing effect is generated. Thus fastening is firmer. The compression is evenly distributed on the contact area of the first section 311 and the surface of the wall W (rather local points of a small portion), hence stress concentration does not occur around the rim of the working hole B, and construction quality can be enhanced.

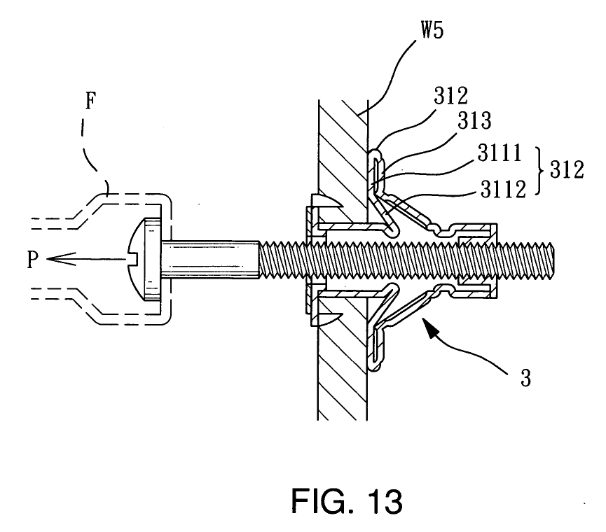

Refer to FIG. 13 for the invention in use on a wall W5 of a smaller thickness. After the first section 311 is expanded, a front side 3112 thereof will be bent and suspended due to the channeling force, while a rear side 3111 is still in close contact with the surface of the wall W5. Hence the inverse penetration into the wall after expansion that occurs to the conventional expansion screw does not happen to the invention, and the folding and bracing effect can be maintained.

In addition, the second section 313 and third section 315 may have respectively a reinforced rib 3131 and 3151 to increase the strength to ensure that the bending spots take place on the first and second stamp lines 312 and 314.

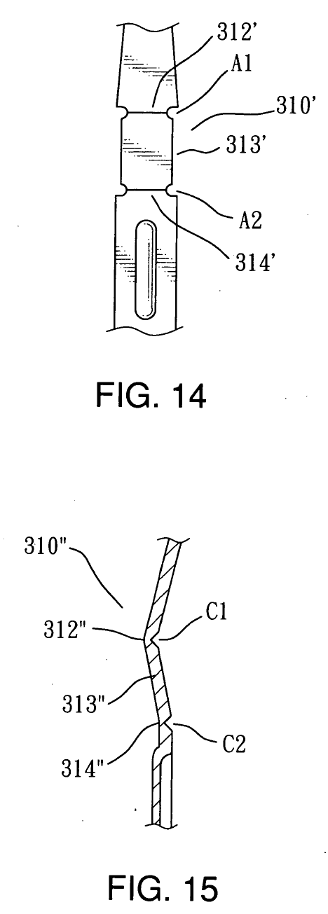

The implementation of the second section may adopt other forms. Refer to FIG. 14 for another embodiment of the second section 313′. It has notches A1 and A2 formed respectively on two lateral sides of the first and second stamp lines 312′ and 314′ to weaken the upper end and lower end (namely where the first and second stamp lines 312′ and 314′ are located) of the second section 313′, and to channel and concentrate the stress to facilitate bending of the second section 313′.

Refer to FIG. 15 for yet another embodiment of the second section 313″. On an the inner side where the first and second stamp lines 312″ and 314″ are formed, there are transverse grooves C1 and C2 to weaken the upper end and lower end (namely where the first and second stamp lines 312″ and 314: are located) of the second section 313″ to channel and concentrate the stress to facilitate bending of the second section 313″.

In short, the invention can improve construction quality. By overlapping the first and second sections after expansion, and with the pressing and bracing of the third section, it generates a bracing support of multiple sections to prevent defective construction and excessive compression on the rim of the construction hole. It provides a significant improvement over the conventional techniques.

I claim:

1. An expansion screw comprising an anchor nail and a bolt, the anchor nail including a tubular body formed by rolling a plate that has an action zone in a middle portion, the action zone having a plurality of longitudinal slots and a plurality of strips, each of the strips having a first section, a second section and a third section; wherein:
the first section is located on a upper side of the strip adjacent to a nail cap and extended downwards and outwards in an inclined manner from an edge of one end of the nail cap to be in contact tightly with the surface of a wall after expansion of the expansion screw;
the second section is located on a lower side of the first section and connected to the first section, and inclines gradually downwards and inwards at a length smaller than the first section to be folded in contact with the first section after the expansion; and
the third section is located on a lower side of the second section and formed in a flat and straight manner to connect to the second section, and is extended downwards until reaching an edge of a head end of the anchor nail and formed at a length greater than the second section to brace the first section after the expansion.

2. The expansion screw of claim 1, wherein the connecting portion of the first section and the second section is extended outwards that has a first stamp line formed by stamping with a mold.

3. The expansion screw of claim 1, wherein the connecting portion of the second section and the third section has a second stamp line formed by stamping with another mold.

4. The expansion screw of claim 1, wherein the second section has two lateral sides shrinking inwards at a width smaller than the width of the first section and the third section.

5. The expansion screw of claim 1, wherein the second section has a upper end and a lower end that have respectively a notch.

6. The expansion screw of claim 1, wherein the second section has a upper end and a lower end that have respectively a transverse groove on an inner side.
